(19) United States
(12) Patent Application Publication
(10) Pub. No.: US 2011/0194404 A1
(43) Pub. Date: Aug. 11, 2011

(54) SYSTEM AND METHOD FOR FAST PROTECTION OF DUAL-HOMED VIRTUAL PRIVATE LAN SERVICE (VPLS) SPOKES

(75) Inventors: Yoav Kluger, Zichron Yakov (IL); Lior Shabtay, Ramat Gan (IL)

(73) Assignee: Nokia Siemens Networks Ethernet Solutions Ltd.

(21) Appl. No.: 12/704,234

(22) Filed: Feb. 11, 2010

(51) Int. Cl. H04J 3/14; H04L 12/28

(52) U.S. Cl. 370/218; 370/395.53

(57) ABSTRACT

A novel and useful system and method for fast protection of dual homed Virtual Private LAN Service (VPLS) spokes. Fast protection is achieved by forwarding traffic to the dual homed VPLS spoke from the VSI that is not currently the one currently serving it, as long as the traffic is known unicast. Egress traffic at the VSI that does not currently serve the VPLS-spoke is re-routed over a protection transport entity to the VPLS-spoke through the device of the VSI currently serving it. Broadcast, multicast and unknown (BMU) traffic is sent to the VPLS spoke only by the BMU-primary VSI. BMU frames received at the BMU-secondary VSI are dropped. A fast election process serves to elect the BMU-primary for coordinating between the two VSIs serving the same VPLS spoke. In addition, a flag is inserted in each frame at an ingress VSI to indicate whether the frame is known or unknown unicast. Unknown unicast frames are forwarded to the VPLS spoke only by the BMU-primary.

### TECHNICAL FIELD

The disclosure relates generally to data communication systems and more particularly relates to a system and method for fast protection of dual homed Virtual Private LAN Service (VPLS) spokes.

### BACKGROUND

The growth in demand for telecommunication services is increasing at an ever-quickening pace. The majority of the demand is being driven by the explosion in the use of the Internet and a steady stream of new applications being introduced which further increase the demand for increased bandwidth. With time, a smaller an smaller portion of Internet traffic is carried by circuit switched transport facilities. In the case of Metropolitan Area Networks (MANs), a significant part of the traffic is transported over SONET/SDH based networks most of which were originally resigned for voice traffic. With time, more and more customers are using the networks for transporting data rather than voice.

The requirements for networked communications within the user community have changed dramatically over the past two decades. Several notable trends in the user community include (1) the overwhelming domination of Ethernet as the core networking media around the world; (2) the steady shift towards data-oriented communications and applications; and (3) the rapid growth of mixed-media applications. Such applications include everything from integrated voice/data/video communications to the now commonplace exchanges of MP3 music files and also existing voice communications which have migrated heavily towards IP/packet-oriented transport.

Ethernet has become the de facto standard for data-oriented networking within the user community. This is true not only within the corporate market, but many other market segments as well. In the corporate market, Ethernet has long dominated at all levels, especially with the advent of high-performance Ethernet switching. This includes workgroup, departmental, server and backbone/campus networks. Even though many of the Internet Service Providers (ISPs) in the market today still base their WAN-side communications on legacy circuit oriented connections (i.e. supporting Frame Relay, xDSL, ATM, SONET) in addition to Ethernet in a significant part of the newer installations, their back-office communications are almost exclusively Ethernet. In the residential market, most individual users are deploying 10 or 100 Mbps Ethernet within their homes to connect PCs to printers and to other PCs (in fact, most PCs today ship with internal Ethernet cards) even though the residential community still utilizes a wide range of circuit-oriented network access technologies.

The use of Ethernet, both optical and electrical based, is increasing in carrier networks due to advantages of Ethernet and particularly Optical Ethernet, namely its ability to scale from low speeds to very high rates and its commodity-oriented nature. With the rapid increase in the demand for user bandwidth, and the equally impressive increase in the performance of Ethernet with the LAN environment, the demand for Metropolitan network performance is rapidly increasing. In response, there has been a massive explosion in the amount of fiber being installed into both new and existing facilities. This is true for both the corporate and residential markets.

Virtual private LAN service (VPLS) is a way to provide Ethernet based multipoint to multipoint communication over Internet Protocol (IP)/Multiprotocol Label Switching (MPLS) networks. It allows geographically dispersed sites to share an Ethernet broadcast domain by connecting sites through pseudo-wires. Example technologies that can be used as pseudo-wire include Ethernet over MPLS, L2TPv3, etc. Two IETF standards that track RFCs describing VPLS establishment include RFC 4761 “Virtual Private LAN Service (VPLS) Using BGP for Auto-Discovery and Signaling” and RFC 4762 “Virtual Private LAN Service (VPLS) Using Label Distribution Protocol (LDP) Signaling”.

VPLS is a virtual private network (VPN) technology which allows any-to-any (multipoint) connectivity. In a VPLS, the local area network (LAN) at each site is extended to the edge of the provider network. The provider network then emulates a switch or bridge to connect all of the customer LANs to create a single bridged LAN.

A VPLS creates an emulated LAN segment for a given set of users. It provides a layer 2 broadcast domain that is capable of learning and forwarding using Ethernet MAC addresses for a given set of users.

Today, Ethernet is the predominant technology used for Local Area Network (LAN) connectivity and is gaining acceptance as an access technology as well. This is true especially in Metropolitan Area Networks (MANs) and Wide Area Networks (WANs). In a typical scenario, an Ethernet port connects a customer to the Provider Edge (PE) device. Customer traffic is subsequently mapped to a specific MPLS-based Layer 2 Virtual Private Network (VPN).

Traditional LANs provide unicast, broadcast and multicast services. Locations that belong to the same broadcast domain and that are connected via an MPLS network expect broadcast, multicast and unicast traffic to be forwarded to the proper locations. This requires MAC address learning on a per LSP basis, forwarding unicast destination traffic according to the learned information, packet replication across LSPs for multicast/broadcast traffic and for flooding of unknown unicast destination traffic.

A main goal of Virtual Private LAN Services (VPLS) is to provide connectivity between customer sites situated in the MAN or WAN as if they were connected via a LAN. To accomplish this, a major attribute of Ethernet must be provided, namely the flooding of broadcast traffic, multicast traffic, and traffic with unknown destination MAC addressed to all ports. To provide flooding within a VPLS, all unicast unknown address, broadcast and multicast frames are flooded over the corresponding “pseudo-wires” to all relevant provider edge nodes that participate in the VPLS. Note that multicast packets are a special case and are not necessarily flooded to all VPN members. A pseudo-wire is a made up of a pair of unidirectional virtual circuit Label Switched Paths (LSPs). Throughout this document, the terms pseudo-wire and transport-entity are used to denote a point-to-point logical link connecting different nodes in the network, regardless of the technology used for its implementation, e.g., MPLS, etc. Depending on the technology, the pseudo-wire may be an MPLS-VC, a point-to-point VLAN-based trail, an ATM-VC, etc.

A provider edge node uses different techniques to associate packets received from the client with connections. Example techniques include port mapping and VLAN mapping in which the received packet is associated with a connection according to the provider edge device port from which it was received or according to the port from which it was received as well as the VLAN with which it is tagged, respectively. Packets mapped to a VPLS connection, are forwarded to one or more of the sites associated with that particular VPLS connection. In case of a VPLS connection, the forwarding is performed by bridging-capable nodes throughout the network, that bridge between pseudo-wires dedicated to that VPLS. The pseudo-wires are point-to-point ‘sub-connections’ of that VPLS, functioning to connect the bridging-capable nodes. These bridging capable nodes must be able to first associate the received packet with a VPLS and then, within the context of the VPLS, associate a destination MAC address (or a destination MAC-address and VLAN-tag value) with a pseudo-wire comprising that VPLS in order to forward a packet. It is not practical to require these provider nodes to statically configure an association of every possible destination MAC address with a pseudo-wire. Thus, a bridging mechanism is required to dynamically learn MAC addresses (or MAC-address and VLAN pairs) on both physical ports and virtual circuits and to forward and replicate packets across both physical ports and pseudo-wires to which they are associated.

Provider edge (PE) devices participating in a VPLS-based VPN must appear as an Ethernet bridge to connected customer edge (CE) devices. Received Ethernet frames must be treated in such a way as to ensure CEs can be simple Ethernet devices. When a PE receives a frame from a CE, it inspects the frame and learns the source MAC address, storing it locally along with LSP routing information. It then checks the frame's destination MAC address. If it is a broadcast or multicast frame, or the MAC address is not known to the PE, it floods the frame to all PEs in the mesh.

Bridging functionality operates on the original Layer 2 portion of the packet. The bridge functions to learn new source MAC addresses of ingress packets and to associate them with the outbound pseudo-wire it is to be sent out on.

Various techniques can be used to provide the forwarding functionality in a layer-2 VPN. One technique is known as spanning-tree based transparent bridging as described in the IEEE 802.1 standard. In this bridging technique the nodes in the network connect through a tree of point-to-point pseudo-wires. Standard bridging is performed between them using the pseudo-wires between them as links over which bridging is performed.

A second bridging technique is a variation of the first one described above and is knows as split-horizon bridging in which each endpoint of the VPLS is connected through a point-to-point pseudo-wire to each of the other components. Each endpoint performs a bridging decision as to whether to forward each packet to a specific destination through the point-to-point pseudo-wire leading to it, or to forward the packet to all or some of the destinations (i.e. through all or some of the point-to-point pseudo-wires). Thus, all bridges are connected in a full mesh pattern whereby packets pass at most only two bridges. A disadvantage of this technique is that it is not scalable and thus requires a large number of pseudo-wires as the VPLS size increases (in the number of endpoints). This technique is the basic bridging technique used between VPLS VSIs in RFC 4761 and RFC 4762.

A third technique known as link redundancy uses a single bridging device connected in a dual-homed fashion to a bridging domain using two different pseudo-wires. The device chooses one of the pseudo-wires for working at any single point in time. In Hierarchical-VPLS, as defined in RFC 4762, such a bridging-device is called a VPLS-spoke, and can be connected in a dual-homed or single-homed fashion to one or two VPLS VSIs.

### SUMMARY

There is thus provided a method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising detecting a failure in the primary transport entity, switching transmission of ingress traffic to the second VSI over the secondary transport entity in response to the failure, rerouting egress traffic from the first VSI to the second VSI for forwarding to the VPLS spoke over the secondary transport entity in response to the failure, electing the VSI the VPLS spoke sends ingress traffic to as the broadcast, multicast, unknown (BMU)-primary VSI and electing the other VSI as BMU-secondary and wherein if both the first and second VSIs receive a BMU frame, only the BMU-primary VSI forwards the BMU frame to the VPLS spoke thereby preventing duplicate broadcast, multicast, unknown (BMU) frames at the VPLS spoke.

There is also provided a method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising upon occurrence of a switch-causing event, switching transmission of ingress traffic to the second VSI over the secondary transport entity in response to the switch-causing event, rerouting egress traffic from the first VSI to the second VSI for forwarding to the VPLS spoke over the secondary transport entity in response to the switch-causing event, electing the VSI the VPLS spoke sends ingress traffic to as the broadcast, multicast, unknown (BMU)-primary VSI and electing the other VSI as BMU-secondary and wherein if both the first and second VSIs receive a BMU frame, only the BMU-primary VSI forwards the BMU frame to the VPLS spoke thereby preventing duplicate broadcast, multicast, unknown (BMU) frames at the VPLS spoke.

There is further provided, a method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising detecting a failure in the primary transport entity, electing the VSI the VPLS spoke sends ingress traffic to as the broadcast, multicast, unknown (BMU)-primary VSI, switching transmission of ingress traffic from first VSI to the second VSI over the secondary transport entity in response to the failure, rerouting egress traffic from the first VSI to the second VSI for forwarding to the VPLS spoke over the secondary transport entity in response to the failure, marking unicast frames with an indication of whether they are known or unknown and permitting only the BMU-primary VSI to forward BMU frames to the VPLS spoke thereby preventing duplication of BMU frames at the VPLS spoke.

There is also provided a method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising upon occurrence of a switch-causing event, electing the VSI the VPLS spoke sends ingress traffic to as the broadcast, multicast, unknown (BMU)-primary VSI in response to the switch-causing event, switching transmission of ingress traffic from first VSI to the second VSI over the secondary transport-entity in response to the switch-causing event, rerouting egress traffic from the first VSI to the second VSI for forwarding to the VPLS spoke over the secondary transport entity in response to the switch-causing event, marking unicast frames with an indication of whether they are known or unknown and permitting only the BMU-primary VSI to forward BMU frames to the VPLS spoke thereby preventing duplication of BMU frames at the VPLS spoke.

There is further provided a switch for use in an Ethernet based network incorporating a Local Area Network (LAN) Service (VPLS) Virtual Switch Instance (VSI) to which a VPLS-spoke is connected through a primary transport entity, where the VPLS spoke device is also connected to a second VSI over a secondary transport entity, the switch comprising a plurality of network ports for interfacing the switch to one or more communication links, a packet processor comprising an ingress packet processor and an egress packet processor, a fast protection module operative to detect a failure in the primary transport entity, receive unicast frames, marked at an ingress VSI in the network as to whether they are known at it or not, reroute egress traffic and all unicast traffic that is marked as known and that needs to be sent to the VPLS-spoke to the second VSI for forwarding to the VPLS spoke over the secondary transport entity.

### BRIEF DESCRIPTION OF THE DRAWINGS

The mechanism is herein described, by way of example only, with reference to the accompanying drawings, wherein:

FIG. 1 is a diagram illustrating an example network incorporating multiple dual homed VPLS spoke sites;

FIG. 2 is a diagram illustrating an example network with a link failure in a primary link of a dual homed VPLS spoke site;

FIG. 3 is a flow diagram illustrating an example protection path provisioning method;

FIG. 4 is a flow diagram illustrating an example fast protection method;

FIG. 5 is a flow diagram illustrating an example BMU traffic duplication prevention method;

FIG. 6 is a diagram illustrating the forwarding of a BMU frame in an example network;

FIG. 7 is a flow diagram illustrating an example method of egress processing of unicast frames at the VSIs;

FIG. 8 is a flow diagram illustrating an example method of marking frames;

FIG. 9 is a diagram illustrating the forwarding of a known unicast frame in an example network; and

FIG. 10 is a functional block diagram illustrating an example switch incorporating the fast protection mechanism.

### DETAILED DESCRIPTION

### Notation Used Throughout

The following notation is used throughout this document.

| Term | Definition |
|---|---|
| ASIC | Application Specific Integrated Circuit |
| ATM | Asynchronous Transfer Mode |
| BGP | Border Gateway Protocol |
| BMU | Broadcast, Multicast, Unknown |
| CCM | Continuity Check Message |
| CD-ROM | Compact Disc-Read Only Memory |
| CE | Customer Equipment |
| CPU | Central Processing Unit |
| CSIX | Common Switch Interface |
| DAT | Digital Audio Tape |
| DSL | Digital Subscriber Line |
| DSP | Digital Signal Processor |
| DVD | Digital Versatile Disk |
| EEPROM | Electrically Erasable Programmable Read Only Memory |
| EPROM | Erasable Programmable Read Only Memory |
| FDDI | Fiber Distributed Data Interface |
| FE | Fast Ethernet |
| FPGA | Field Programmable Gate Array |
| GE | Gigabit Ethernet |
| HDL | Hardware Description Language |
| IC | Integrated Circuit |
| IEEE | Institute of Electrical and Electronic Engineers |
| IETF | Internet Engineering Task Force |
| IP | Internet Protocol |
| ISO | International Organization for Standardization |
| ISP | Internet Service Provider |
| ITU | International Telecommunication Union |
| LAN | Local Area Network |
| LSP | Label Switched Path |
| LSR | Label Switched Router |
| MAC | Media Access Control |
| MAN | Metropolitan Area Network |
| MPLS | Multi-Protocol Label Switching |
| MSB | Most Significant Bit |
| NIC | Network Interface Card |
| NMS | Network Management System |
| OAM | Operations, Administration & Maintenance |
| OSE | Operating System Embedded |
| OSI | Open System Interconnection |
| OSPF | Open Shortest Path First |
| PC | Personal Computer |
| PDH | Plesiochronous Digital Hierarchy |
| PDU | Protocol Data Unit |
| PE | Provider Edge |
| PPE | Packet Processing Engine |
| PW | Pseudowire |
| RAM | Random Access Memory |
| RFC | Request for Comment |
| RPR | Resilient Packet Ring |
| SDH | Synchronous Digital Hierarchy |
| SDIO | Secure Digital I/O |
| SONET | Synchronous Optical Network |
| TCP | Transmission Control Protocol |
| TDM | Time Division Multiplexing |
| TLV | Type, Length, Value |
| UNI | User to Network Interface |
| USB | Universal Serial Bus |
| VC | Virtual Circuit |
| VLAN | Virtual LAN |
| VPLS | Virtual Private LAN Service |
| VPN | Virtual Private Network |
| VSI | Virtual Switch Instance |
| WAN | Wide Area Network |

### DETAILED DESCRIPTION

The mechanism will now be described more fully hereinafter with reference to the accompanying drawings, in which preferred embodiments of the mechanism are shown. The mechanism may, however, be embodied in many different forms and should not be construed as limited to the embodiments set forth herein. Rather, these embodiments are provided so that this disclosure will be thorough and complete, and will fully convey the scope of the mechanism to those skilled in the art. Like numbers refer to like elements throughout, and prime notation is used to indicate similar elements in alternative embodiments.

To aid in illustrating the principles of the mechanism, an example network is presented in connection with the fast protection mechanism. An example embodiment is provided to illustrate the fast protection mechanism of the present invention. It is not intended, however, that the mechanism be limited to the configurations and embodiments described herein. It is appreciated that one skilled in the networking, electrical and/or software arts may apply the principles of the mechanism to numerous other types of networking devices and network configurations as well, including other types of synchronous data streams and asynchronous transport networks without departing from the scope of the mechanism.

Many aspects of the mechanism described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

Throughout this document, the terms packet and frame are used interchangeably and are intended to denote a protocol data unit (PDU) adapted to transport data and/or control information from one point to another. References are made to Ethernet frames, IP packets, etc. which are example protocol data units (PDUs) associated with various networks such as Ethernet, H.323, ISO OSI TCP/IP protocol stack. It is appreciated, however, that the mechanism may be adapted for use in other types of networks that transmit other types of PDUs as well. The principles of MAC based transmission as described herein are not limited to Ethernet MAC devices and can be applied to other types of Layer 2 protocols and devices as well.

The most popular types of VPLS-spokes are VLAN-spokes and MPLS-spokes. A VLAN spoke is a spoke site that resides in a non-MPLS, VLAN enabled network device (e.g., according to IEEE 802.1Q or 802.1ad). A MPLS spoke is a spoke site that resides in an MPLS enabled network device. Such a spoke is connected to one or two VPLS VSIs through MPLS transport entities (e.g., pseudo-wires).

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media.

The word ‘exemplary’ is used herein to mean ‘serving as an example, instance, or illustration.’ Any embodiment described herein as ‘exemplary’ is not necessarily to be construed as preferred or advantageous over other embodiments.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the mechanism, discussions utilizing terms such as ‘processing,’ ‘computing,’ ‘calculating,’ determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices or to a hardware (logic) implementation of such processes.

The flowchart and block diagrams in the Figures illustrate the architecture, functionality, and operation of possible implementations of systems, methods and computer program products according to various embodiments of the present mechanism. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Note that the mechanism can take the form of an entirely hardware embodiment, an entirely software embodiment or an embodiment containing a combination of hardware and software elements. In one embodiment, a portion of the mechanism can be implemented in software, which includes but is not limited to firmware, resident software, object code, assembly code, microcode, etc.

Furthermore, the mechanism can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (embedded or removable in the form of, e.g., USB flash drive, SDIO module, etc.), ROM, EPROM, or other semiconductor memory devices.

### Example Network

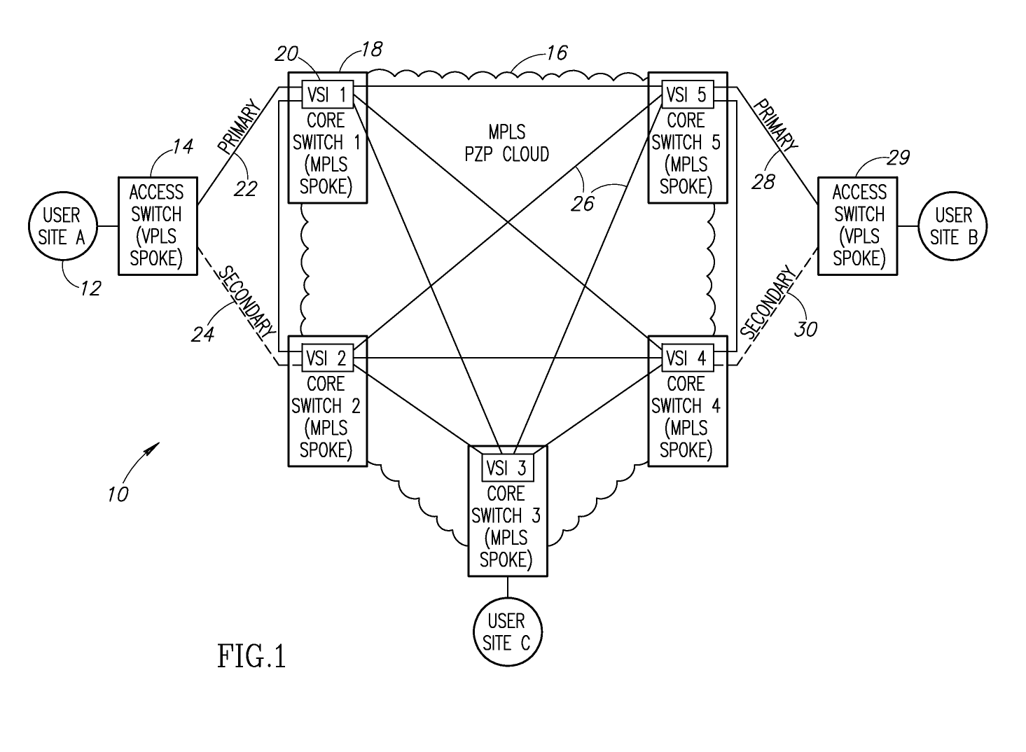

A diagram illustrating an example network incorporating multiple dual homed VPLS spoke sites is shown in FIG. 1. The example network, generally referenced 10, comprises an MPLS P2P cloud 16 including a plurality of MPLS core switches 18, labeled core switches 1, 2, 3, 4 and 5, connected in a full mesh to all other core switches via transport entities 26 (e.g., MPLS pseudo-wires (PWs)). A plurality of access switches 14 (functioning as VPLS spokes) connect user sites to the MPLS network. In particular, user site A is connected to the MPLS cloud via access switch 14 which is connected to both MPLS core switch 1 via primary transport entity 22 (solid line) and MPLS core switch 2 via transport entity 24 (dashed line) in a dual homing arrangement. Similarly, user site B is connected to the MPLS cloud via access switch 29 which is connected to both MPLS core switch 5 via primary transport entity 28 (solid line) and MPLS core switch 4 via transport entity 30 (dashed line) in a dual homing arrangement. User site C is connected directly to core switch 3. Each of the core switches implement a plurality of Virtual Switch Instances (VSIs). For example, VSI1 on core switch 1, VSI2 on core switch 2, VSI3 on core switch 3, VSI4 on core switch 4 and VSI5 on core switch 5. The network may also include core switches that do not include VSIs. The pseudo-wires may flow through MPLS-LSPs (or other types of tunnels) that flow through them. The transport entities 22, 24, 28, and 30 may be implemented using VLAN-based trails, PWE3 pseudo-wires, etc.

Virtual Switching Instances (VSIs) are maintained by the MPLS core switches and function to deliver layer 2 VPNs, VPLS. VSIs maintain MAC address entries for a particular VPLS. In a VSI, MAC addresses are learned on transport entities (e.g., pseudo-wires, VLAN-trails) (just as a Layer 2 switch learns MAC addresses on ports).

The VPLS spokes (e.g., access switches) and the VSIs on core switches are interconnected via transport entities (e.g., pseudo-wires, VLAN-trails) and provide a layer-2 VPN service that appears as a single emulated LAN to the user site stations. The core switches interconnect access-devices as well as directly-connected user sites, and provide bridging therebetween. Access devices may also contain a bridging function between their UNIs and the pseudo-wires/transport-entities belonging to the VPLS. Each device having VPLS bridging functionality is adapted to learn remote MAC address (or MAC address and VLAN tag) to pseudo-wire/transport-entity associations from traffic received over these pseudo-wires/transport-entities and to also learn source MAC address to user port associations from traffic received over user ports.

One of two methods for provisioning a VPLS is typically used: a management based method or signaling based method. With management based provisioning, a management entity allocates the bridging resources to be used at the different nodes and provisions the pseudo-wires between them. With signaling based provisioning, the provider edge device typically comprises an edge router capable of running a signaling protocol and/or routing protocols used to configure pseudo-wires. In addition, it is capable of configuring transport tunnels to other provider edge devices and transporting traffic over a pseudo-wire.

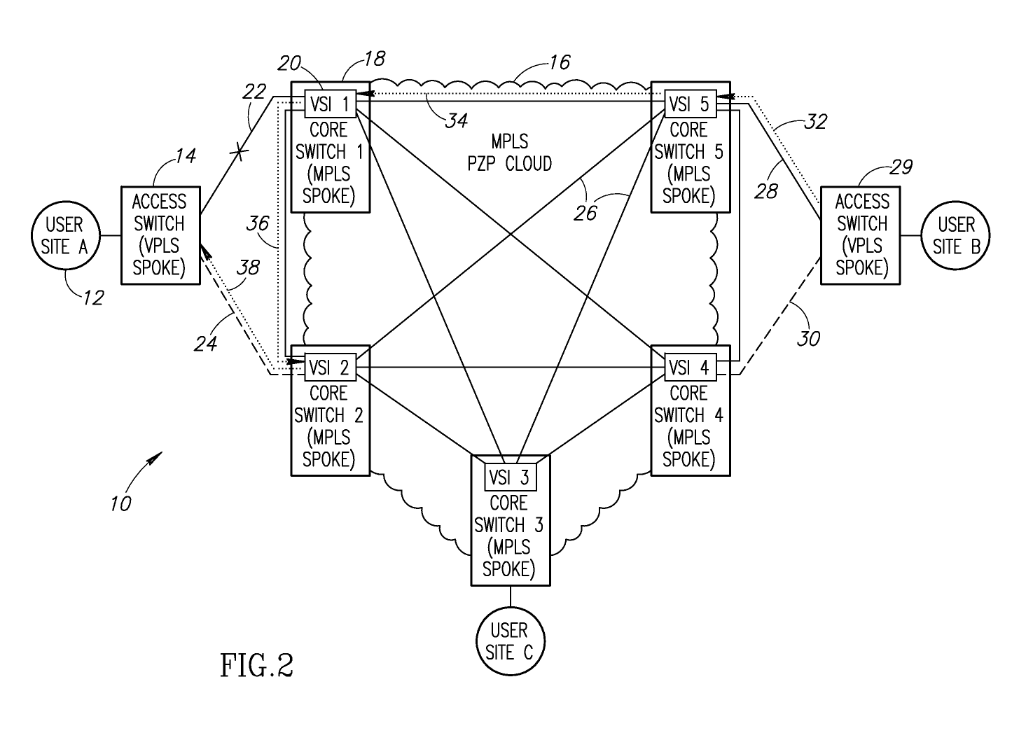

As shown in FIG. 1, a dual homed VPLS spoke is connected to two VPLS VSIs over two transport entities, one primary (solid line) and the other secondary (dashed line). Upon a failure of the currently-used transport entity, the VPLS spoke immediately begins using the other. Consider the example network 10 of FIG. 2 wherein the primary transport entity 22 fails. Note that the event causing protection-switching as described above may be an actual failure of the link or network device causing a failure of the currently used transport-entity, as well as manual-switch command by the operator, or expiration of a reversion-timeout in the case revertive operation is in use, etc. For illustration purposes only, the mechanism is described in the context of a failure. It is appreciated, however, that the mechanism may be activated for any other reason such as described above.

With the primary transport entity down, VSI1 drops egress frames destined to user site A. Ingress frames from user site A are switched to the secondary transport entity 24 to VSI2. In the egress direction, a dual homing VPLS spoke closes the transport entity that failed. After switching VSIs (from primary to secondary), unicast traffic will not reach the VPLS spoke since its MAC addresses are still learned to reside in the former interface (VSI1).

Normally, detection of the failure may be by an Operation, Administration and Maintenance (OAM) protocol or by applying a spanning tree protocol over the transport entities. In one solution, the VSI that detects the topology change or failure sends a MAC withdrawal message that initiates a procedure of erasing the old MAC information from the forwarding tables of the VSIs involved in the VPLS service. In the example network of FIG. 2, VSI1 floods a MAC withdrawal message with a list of MAC addresses that are behind user site A. In response, all other VSIs delete their corresponding MAC entries in their database. Alternatively, VSIs floods an empty MAC withdrawal message. In response, all VSIs delete entries that have VSI1 as their destination. Other VSIs will now be forced to flood message traffic as unknown frames because their MAC tables have been cleared. When devices in user-site A send data-frames, the VSIs re-learn the MAC addresses that lie behind that user site. Thus, the VPLS completely recovers from a failure protection only after all MAC addresses behind the VPLS spoke that switched sides (user site A) are deleted or learned in all VSIs to reside at the newly selected interface (i.e. VSI2 and secondary transport entity). In other words, protection is not complete until all the VPLS VSIs in the network learn the new MAC table information resulting from the new topology. This takes a relatively long time (possibly tens of seconds) especially considering that the number of MAC stations in a carrier network may number in the 1000s, 10,000s or more. Thus, a desirable protection time of sub 50 ms (SONET) is unachievable. The long delay is typically attribute to the fact that almost all the connected MAC stations will attempt to send traffic at the same time, with the resultant flooding of messages, which quickly overwhelms the network, significantly lowering network performance for all users. In addition, the process of sending the MAC-withdrawal messages and deleting the respective MAC-addresses from the MAC-tables of the VSIs is also a process that takes time and in most cases may take considerably more than 50 ms. During the time in which the ‘old’ MAC-address entries (i.e. not yet updated) are still in the forwarding tables, frames having these MAC-addresses as their destination MAC-addresses will not reach their destination.

As described supra, upon failure of the connectivity between a dual homed VPLS spoke and its currently selected VSI, the VPLS spoke switches to use the other VSI. Referring to the example network of FIG. 2, the VPLS spoke 14 switches to use VSI2 (via secondary transport entity 24) after a failure is detected in the primary transport entity 22. The actual time it takes for this to happen depends on the mechanism used to detect the failure. If rapid OAM is used, the time can be sub 50 ms. Thus, in the ingress direction, protection time depends on the OAM mechanism time and could be sub 50 ms. Moreover, as explained above, until the process of sending MAC-withdrawal messages and deleting or updating the respective entries from the MAC-tables is complete, connectivity protection may be lacking, since frames will not be routed to their destinations.

Protection in the egress direction, however, is normally much slower, as the VPLS spoke now connects to a different VSI (i.e. VSI2) and all VSIs need to update their MAC forwarding tables accordingly. The fast protection mechanism is operative to improve the protection time in the egress direction. The mechanism ensures that traffic destined to user site A that is forwarded according to the old forwarding table (i.e. to VSI1) still reaches the VPLS spoke and is forwarded to the respective UNI port.

This is achieved as follows. When a VSI needs to forward a frame to a VPLS spoke that currently selected the other VSI (i.e. VSI2), it re-routes the frame to reach the VPLS spoke through the transport entity that connects it to the other VSI (i.e. the currently active transport entity 24 to VSI2).

For example consider the path taken (dotted lines) for frames sent from user site B to user site A. The frames are sent over link 32 to VSI5. At VSI5 they are forwarded over link 34 to VSI1 according to the old forwarding tables in VSI5. VSI1, however, re-routes the frame over link 36 to VSI2 where they are then forwarded to the VPLS spoke over link 38. Note that frames arrive at user site A without the requirement of flooding MAC withdrawal messages.

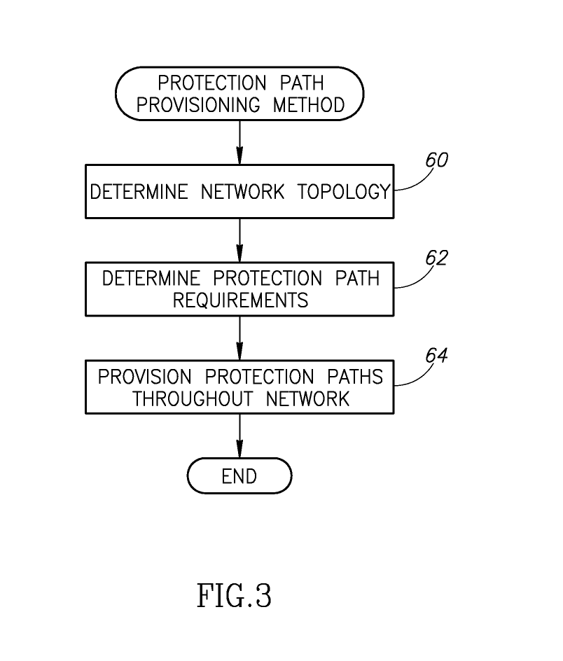

The re-route paths between VSIs, however, are provisioned a priori. A flow diagram illustrating an example protection path provisioning method is shown in FIG. 3. First, the network topology is determined using any suitable means (step 60). The protection path requirements between VSIs are then determined (step 62). The requirements may be provided by the network operator or other sources. The required protection paths are then provisioned throughout the network using any suitable means (step 64).

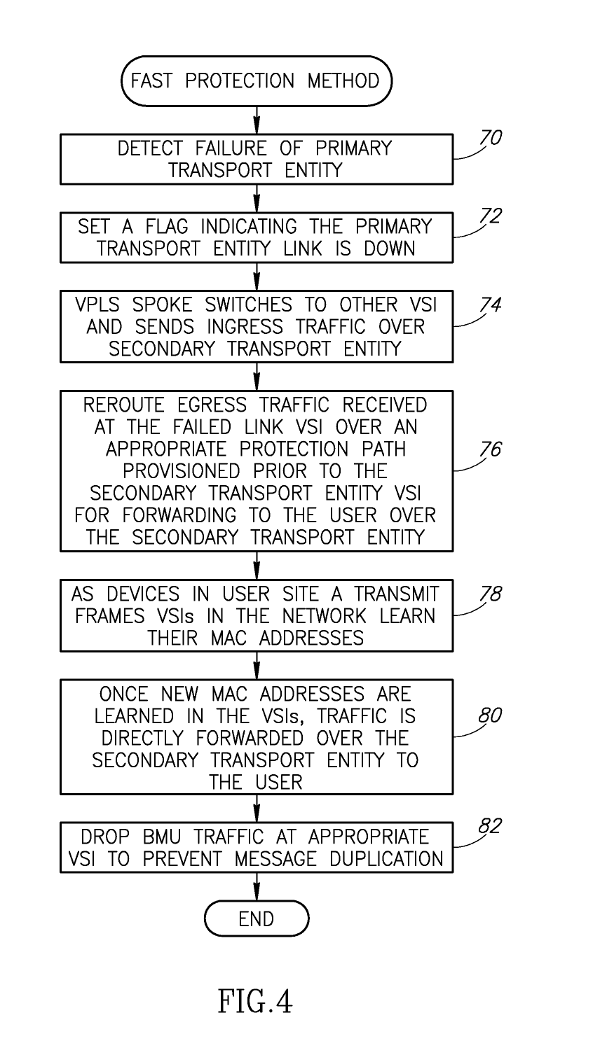

A flow diagram illustrating an example fast protection method is shown in FIG. 4. With reference to both FIGS. 2 and 4, initially, the failure of the primary transport entity is detected by VSI1 and by the VPLS-spoke (step 70). In response, a flag is set in the VPLS spoke and VSI1 that the primary transport entity link is down (step 72). The VPLS spoke then switches ingress traffic to the other VSI (VSI2) and sends the ingress traffic over the secondary transport entity (step 74).

Egress traffic received at the failed link VSI (VSI1) is re-routed over an appropriate protection path provisioned a priori to the secondary transport entity VSI for forwarding to the user over the secondary transport entity (step 76). As devices in user site A transmit frames, VSIs in the network learn their MAC addresses in accordance with conventional MAC learning procedures (step 78). Once new MAC addresses are learned in the VSIs, traffic is directly forwarded over the secondary transport entity to the user (step 80). In addition, to prevent message duplication at the VPLS spoke, Broadcast, multicast, unknown (BMU) traffic is dropped at the appropriate VSI (VSI1) (step 82). An example method of avoiding BMU traffic duplication at the VPLS spoke is described in more detail infra.

It is noted that although the methods and examples described herein are presented with the failure occurring in the primary transport entity, the methods and examples are equally applicable to the case of the occurrence of a failure in the secondary transport entity. In this case, the roles of VSI1 and VSI2 are reversed.

Switching the roles between the two VSIs (i.e. having the VPLS-spoke switch to use the other transport entity), can be activated not only by failures, as described supra, but also due to other events, e.g., manual-switch command by the operator, or expiration of a reversion-timeout in the case revertive operation is in use. The same behavior applies to these cases as well.

Several examples of how a VSI (e.g., VSI1) can send egress traffic through the transport entity that connects the VPLS spoke to the other VSI (e.g., VSI2) include the following. In one example, the frame is sent from VSI1 to VSI2 over the transport entity connecting the two with an indication telling VSI2 to send the frame to the specific VPLS spoke. The indication may be inserted in any suitable location in the frame, for example by an additional MPLS-label, by a new field in the pseudo-wire (PWE3) control-field, or by adding a special-purpose header to the frame. In a second example, in the case of a VPLS spoke, an MPLS tunnel leads to the other VSI node (VSI2). VSI1 sends the frame through it with a label that leads to the port and VLAN to which the spoke is connected. In a third example, in the case of an MPLS spoke, an MPLS tunnel leads to the VPLS spoke, routed through the node of the other VSI (VSI2) and ends at the VPLS spoke node. The label used is the transport entity label that identifies the transport entity between the other VSI (VSI2) and the VPLS spoke. Alternatively, the MPLS spoke forwards traffic coming from the transport-entity leading from the not currently-used VSI (VSI1) to the user-site, while VSI1 still sends known unicasts to the transport-entity leading directly to the MPLS spoke, according to its local MAC-forwarding table. This alternative is relevant only in case the protection-switching was not a result of a failure of that transport-entity, or in case that transport-entity itself is protected.

In accordance with conventional VPLS, broadcast, multicast and unknown frames (also referred to as BMU traffic) are duplicated to all VSIs. The fast protection mechanism, however, requires both VSIs, i.e. the VSI that detects the failure and the VSI used in the fast re-route protection scheme (e.g., VSI1 and VSI2), to send traffic to the VPLS spoke. Thus, there is a likelihood that BMU traffic will get duplicated at the VPLS spoke. The mechanism comprises a method of preventing the duplication of BMU traffic. In accordance with the method, one of the two VSIs to which the VPLS spoke is connected (e.g., VSI1 and VSI2) is elected as BMU-primary and the other as BMU-secondary. Once the election is made, only the BMU-primary VSI is permitted to send BMU traffic to the VPLS-spoke. Note that preferably, election of the BMU-primary is performed after each failure, in order to ensure that the BMU-primary is alive and preferably the one that currently serves the VPLS-spoke.

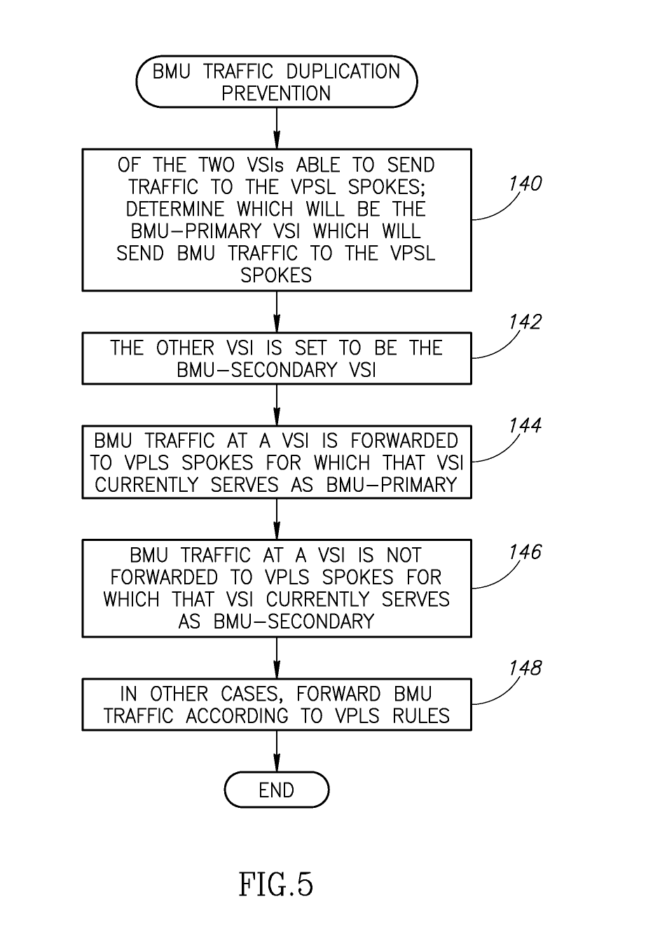

A flow diagram illustrating an example BMU traffic duplication prevention method is shown in FIG. 5. Of the two VSIs able to send traffic to the VPLS spoke (e.g., VSI1 and VSI2), it is determined (via an election process between the two VSIs) which will be the BMU-primary VSI (VSI2) which will send BMU traffic to the VPLS spoke (step 140). The other VSI (VSI1) is set to be the BMU-secondary VSI (step 142). Once the election is made, BMU traffic at a VSI (e.g., VSI2) is forwarded to VPLS spokes for which that VSI currently serves as BMU-primary (step 144).

BMU traffic at a VSI is not forwarded to VPLS spokes for which that VSI (e.g., VSI1) currently serves as BMU-secondary (step 146). In other cases, BMU traffic is forwarded according to conventional VPLS rules (step 148).

Note that broadcast and multicast frames can be identified according to their destination MAC address. Both broadcast and multicast frames have their MSB set to one, thus making them relatively simple to identify. Once identified, these frames are forwarded by the VSI to VPLS spokes for which it currently serves as BMU-primary.

Several examples of the process of electing the BMU-primary to be the VSI to which the VPLS spoke sends traffic, include the following. In a first example, an ‘using alternative side’ flag can be added in a new TLV, to the OAM protocol (e.g., IEEE 802.1ag CCM) used between switches, that can function to keep each of the VSIs informed of whether it is the BMU-primary VSI. In a second example, conventional IEEE 802.1ag/Y.1731 Continuity Check Message (CCM) can be used for this purpose. In this case, the VPLS spoke informs the two VSIs which has been elected BMU-primary by setting the optional interface status TLV as ‘interface-up’ when sending CCMs to the BMU-primary VSI and as ‘interface-down’ when sending CCMs to the BMU-secondary VSI. In a third example, a specific message is used that is sent by the VPLS spoke upon switching VSIs (e.g., from VSI1 to VSI2). The message can also be sent periodically as well. Further, the information can be extracted from topology updates distributed by other means, e.g., OSPF, Spanning-Tree Protocol, etc. In each of these cases, if the OAM procedure in a VSI indicates that the connectivity to the VPLS spoke is lost, the VSI concludes that it is the BMU-secondary.

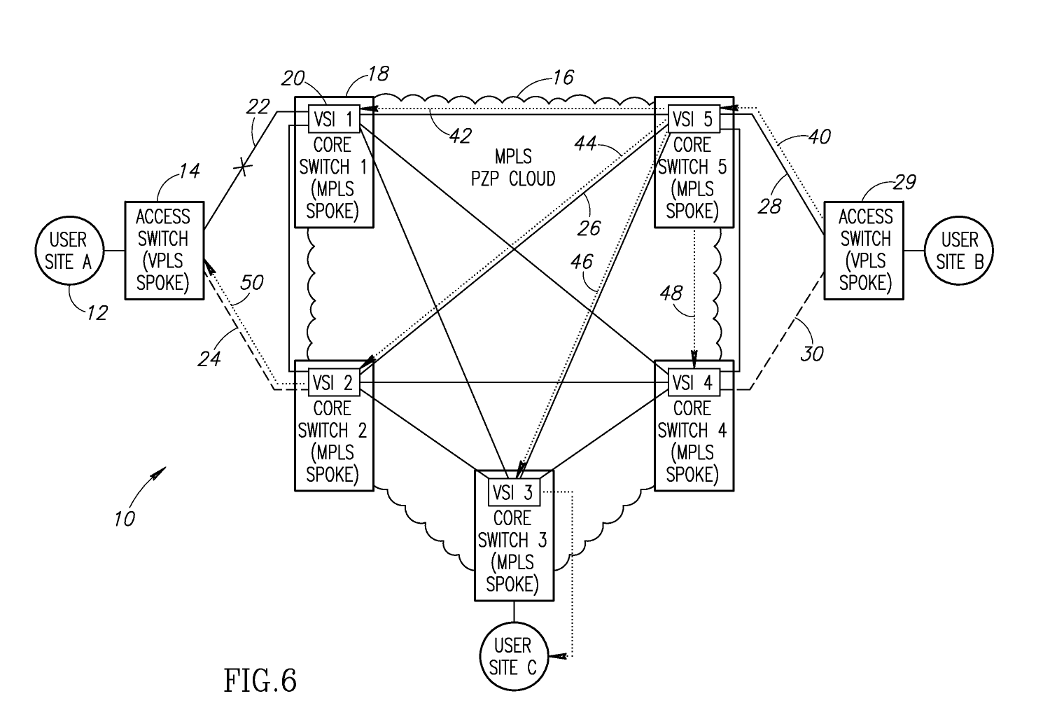

A diagram illustrating the forwarding of a BMU frame in an example network is shown in FIG. 6. Consider a frame sent by the VPLS spoke access switch coupled to user site B. The frame is received at VSI5 over link 40 (dotted line) on transport entity 28. Assuming it is either broadcast, multicast or unknown, VSI5 will flood the frame to all other VSIs (and potentially also to user-sites and VPLS spokes that are directly connected to it), in particular to VSI1 over link 42, to VSI2 over link 44, to VSI3 over link 46, to VSI4 over link 48. VSI1 and VSI2 have elected between themselves that VSI2 is the BMU-primary VSI and VSI1 is the BMU-secondary VSI of the VPLS-spoke of site A. Since VSI1 is not BMU-primary for the VPLS spoke of user site A, it will drop the frame. VSI2, however, forwards the frame to the VPLS spoke since VSI2 is BMU-primary for that VPLS spoke.

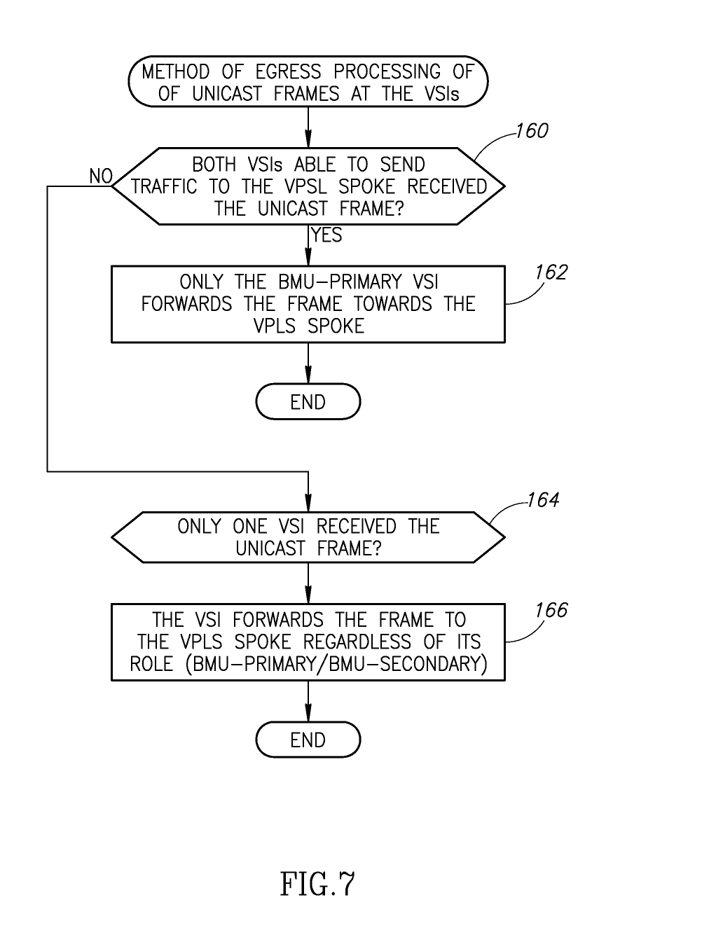

A flow diagram illustrating an example method of egress processing of unicast frames at the VSIs is shown in FIG. 7. The method of egress processing of unicast frames depends on whether both VSIs to which the VPLS spoke is connected received the frame. If both VSIs able to send traffic to the VPLS spoke received the unicast frame (step 160), then only the BMU-primary VSI forwards the frame towards the VPLS spoke (step 162). Otherwise, if only one VSI received the unicast frame (step 164), then that VSI forwards the frame to the VPLS spoke regardless of its role (i.e. BMU-primary or BMU-secondary) (step 166). Note that the only case in which both VSIs receive the same unicast frame, is if the frame's destination is unknown at a VSI that forwarded the frame to both of the two VSIs.

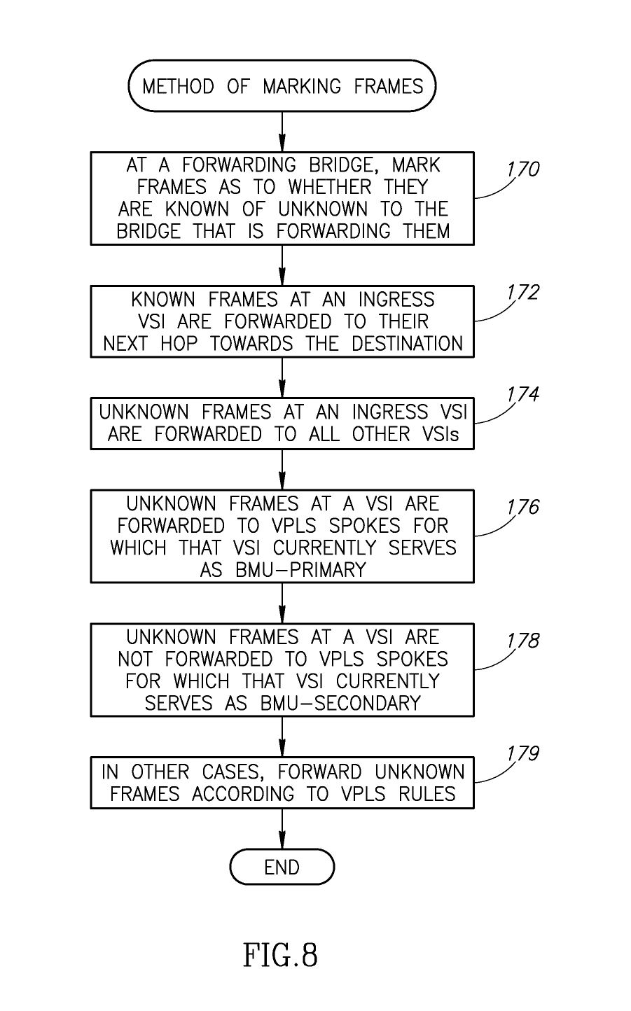

A flow diagram illustrating an example method of marking frames is shown in FIG. 8. The mechanism provides a way to distinguish between the two types of unicast frames (known or unknown) by having a VSI (i.e. bridge) that forwards the frame to other VSIs mark them as to whether they are known or not (step 170). Known frames at an ingress VSI are forwarded to the next-hop device towards the destination (step 172). Note that the next-hop may be an egress VSI, a VPLS-spoke whose active path is currently connected to the ingress-VSI, a user-side directly connected to the ingress VSI, etc. Note that a known frame is one whose destination MAC address is known to the VSI that forwards it.

A frame that is known at an ingress VSI only reaches a single next-hop device. In case that device is a VSI, the frame can be forwarded by that VSI to the VPLS spoke regardless of its role (BMU-primary/BMU-secondary). A frame that is unknown in the ingress VSI is forwarded to all other VSIs (step 174). Unknown frames at a VSI are forwarded to VPLS spokes for which the VSI currently serves as BMU-primary (step 176). Unknown frames at a VSI are not forwarded to VPLS spokes for which that VSI currently serves as BMU-secondary (step 178). In other cases (e.g., user-sites not connected through VPLS-spokes), unknown frames are forwarded according to VPLS rules (step 179).

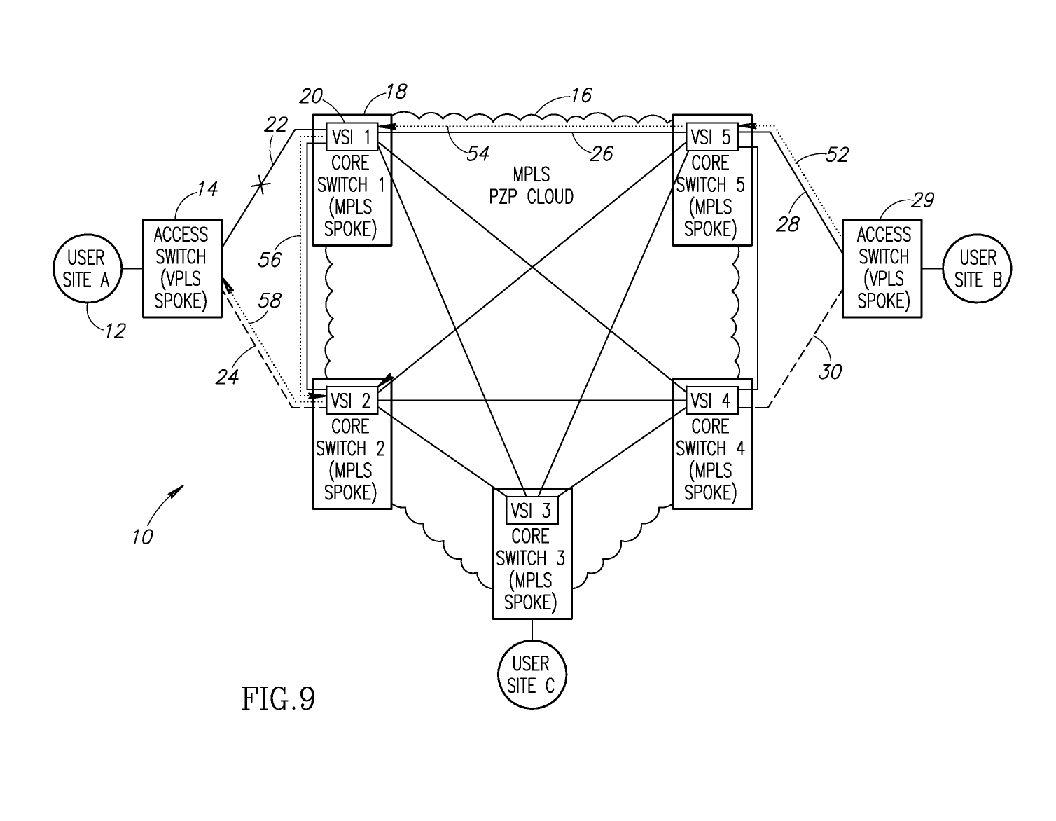

A diagram illustrating the forwarding of a known unicast frame in an example network is shown in FIG. 9. In this example network 10, a unicast frame destined to user site A is sent over link 52 from access switch connected to user site B to VSI5. According to the destination MAC address, the unicast frame is marked as a known frame at VSI5 and sent to VSI1 over link 54 (before any forwarding tables are updated). VSI1 is operative to forward the know unicast frame to VSI2 over protection re-route link 56. VSI2 then forwards the unicast frame to the VPLS spoke 14 via link 58.

### Switch Embodiment

A network device can be adapted to incorporate the fast protection mechanism. Hardware means and/or software means adapted to execute the mechanism may be incorporated within a network device such as a core switch, provider edge switch, Network Management System, Label Switching Router (LSR), Ethernet LAN switch, network switch or any other wired or wireless network device. The device may be constructed using any combination of hardware and/or software.

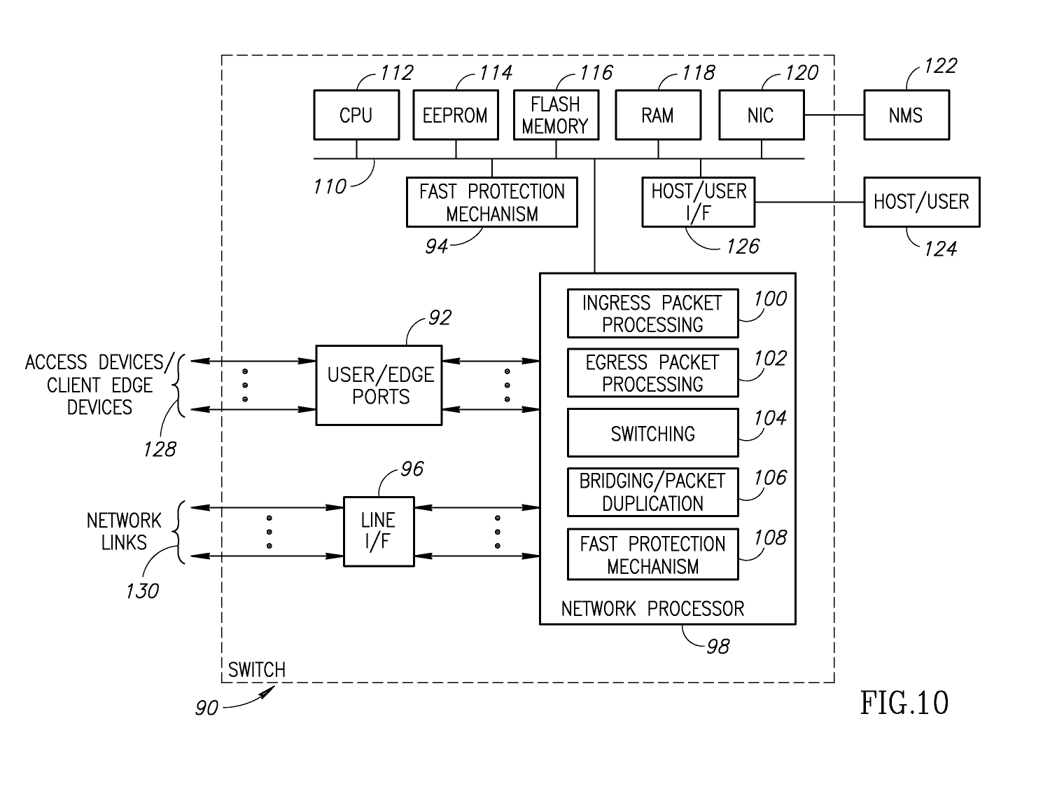

A block diagram of an example switch incorporating the fast protection mechanism of the present invention is shown in FIG. 10. The switch, generally referenced 90, comprises at its core a network processor 98, link or network interface ports 96, edge or user ports 92, a network interface 120 for interfacing the provider edge switch to an NMS 122, a central processor 112, e.g., CPU, and both volatile and non-volatile memory including RAM memory 118 for storing data and application program code, Flash memory 116 for storing boot and application code and EEPROM 114 for storing configuration data. The CPU communicates to the network processor, memory peripherals and other support devices via a bus 110.

The switch 90 comprises a user side and a network side. The one or more line interface cards containing network ports 96 provide the PHY interface to two-way communication links 130. As an example, the line interface cards may be adapted to interface to any combination of the following communication links: any variety of copper or optical based Ethernet, Token Ring, FDDI, SONET/SDH, ATM, RPR, etc.

A plurality of edge ports 92 is provided for connecting directly or indirectly through access/aggregation devices to a plurality of users or customer/client edge devices via links 128. The client edge side interfaces to the user or client edge device via any suitable type of interface, e.g., Gigabit Ethernet (GE), Fast Ethernet (FE), LOGE, SONET/SDH, PDH interface (e.g., T1/E1), etc. Likewise, the network side interfaces to other edge switches or the core network via any suitable interface such as Optical Ethernet (e.g., 1GE, 10GE, etc.), TDM SONET/SDH/PDH, RPR, etc.

A plurality of provider edge switches may be connected to each other to form a stack whereby the provider edge switches at the ends of the stack are connected to core switches. In this case, connections may be built using both VPLS and MPLS based technology. Alternatively, the network may comprise only provider edge switches whereby a plurality of provider edge switches are connected in a ring topology.

The network processor 98 implements the switching fabric (switching block 104) for providing the switching functionality of the device. Depending on the specific implementation, the switching fabric may comprise, for example, hardware for performing VLAN tagging, MPLS, Frame Relay, ATM switching, CSIX or any other fabric to network interface protocol. The network processor includes one or more packet processing engines (PPE) that comprises an ingress packet processor 100 and an egress packet processor 102. The network processor also comprises timestamp circuits, clock circuits, memory, counters and CPU interface (not shown), means for performing OAM protocol (e.g., ITU Y.1731, IEEE 802.1ag, etc.) processing (part of this capability may reside in the CPU as well). The network processor may be implemented as a microcontroller, microprocessor, microcomputer, ASIC core, FPGA core, central processing unit (CPU) or digital signal processor (DSP) or any other suitable computing means.

Module 106 provides bridging and packet duplication services in accordance with the invention as described in more detail hereinabove. Packet counting and data collection services are also provided.

The edge switch also comprises a NIC 120 for providing an out of band interface for connecting to external entities such as a craft for local maintenance and configuration purposes, an NMS for centralized provisioning, administration and control or a Local Area Network (LAN). The network device may comprise additional interfaces, such as a serial interface for connecting to a PC for configuration purposes.

The central processor 112 implements the major functionality of the provider edge switch including higher software layer processing. Note that the central processor may be implemented in any suitable manner such as a microcontroller, microprocessor, microcomputer, ASIC core, FPGA core, central processing unit (CPU) or digital signal processor (DSP) or any other computing means.

The client edge ports and network ports may be implemented on one or more line interface cards that provide the PHY interface to bidirectional communication links, in addition to the MAC interface. Note that the invention is not limited to any particular line interface type or link speed. In addition, the invention is not limited to any particular number of user or network ports, as any number of links of each type may be used. Further, the line interface cards may be adapted to interface to any type of communication links such as any variety of copper or optical based Ethernet, Token Ring, FDDI, SONET/SDH, PDH, ATM, RPR, etc.

The network device also comprises an optional user interface adapted to respond to user inputs and provide feedback and other status information. A host/user interface 126 enables communication with a user or host-computing device 124. The host may be adapted to configure, control and maintain the operation of the device. The device may also comprise magnetic storage device means for storing application programs and data.

The network device comprises computer readable storage medium for storing program code and data which may include any suitable memory means including but not limited to magnetic storage, optical storage, CD-ROM drive, ZIP drive, DVD drive, DAT cassette, semiconductor based volatile or non-volatile memory, biological memory devices, or any other memory storage device.

Note that a network core device may have the same structure as a provider edge device, except for example, not having a user/edge (UNI) port for connecting to client and/or access devices, and having a higher port density and bandwidth capacity.

Software operative to implement the functionality of the fast protection mechanism may be adapted to reside on a computer readable medium, such as a magnetic disk within a disk drive unit or any other volatile or nonvolatile memory. In this example switch, the software adapted to implement the portion of the fast protection mechanism that executes on the network processor is depicted in block 108. In one embodiment, the fast protection software 108 is implemented by the ingress processing block 100 and egress processing block 102. For example, a table, maintained by the CPU, can be used in performing ingress and egress processing. The table comprises VPLS, MPLS and VSI related MAC address and other information. The software adapted to implement the portion of the fast protection mechanism that executes on the general purpose CPU 112 is depicted in block 94. Alternatively, the computer readable medium may comprise a floppy disk, Flash memory, EPROM, EEPROM based memory, ROM storage, etc. The software adapted to perform mechanisms or any portion thereof may also reside, in whole or in part, in the static or dynamic main memories or in firmware within the processor of the switch (i.e. within microcontroller, microprocessor, microcomputer, DSP, etc. internal memory).

In alternative embodiments, the methods of the present invention may be applicable to implementations of the invention in integrated circuits (ICs), field programmable gate arrays (FPGAs), chip sets or application specific integrated circuits (ASICs), DSP circuits, wireless implementations and other communication system products.

The terminology used herein is for the purpose of describing particular embodiments only and is not intended to be limiting of the mechanism. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the mechanism has been presented for purposes of illustration and description, but is not intended to be exhaustive or limited to the mechanism in the form disclosed. As numerous modifications and changes will readily occur to those skilled in the art, it is intended that the mechanism not be limited to the limited number of embodiments described herein. Accordingly, it will be appreciated that all suitable variations, modifications and equivalents may be resorted to, falling within the spirit and scope of the mechanism. The embodiments were chosen and described in order to best explain the principles of the mechanism and the practical application, and to enable others of ordinary skill in the art to understand the mechanism for various embodiments with various modifications as are suited to the particular use contemplated.

What is claimed is:

1. A method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising:
detecting a failure in said primary transport entity;
switching transmission of ingress traffic to said second VSI over said secondary transport entity in response to said failure;
rerouting egress traffic from said first VSI to said second VSI for forwarding to said VPLS spoke over said secondary transport entity in response to said failure;
electing the VSI the VPLS spoke sends ingress traffic to as the broadcast, multicast, unknown (BMU)-primary VSI and electing the other VSI as BMU-secondary; and
wherein if both said first and second VSIs receive a BMU frame, only said BMU-primary VSI forwards said BMU frame to the VPLS spoke thereby preventing duplicate broadcast, multicast, unknown (BMU) frames at the VPLS spoke.

2. The method according to claim 1, further comprising setting a flag in said VPLS spoke and said first VSI to indicate said failure.

3. The method according to claim 1, wherein said egress traffic is rerouted with an indication therein directing said second VSI to forward egress traffic to a particular VPLS spoke.

4. The method according to claim 1, wherein said egress traffic is rerouted via a Multi-protocol Label Switching (MPLS) tunnel leading from said first VSI to said second VSI.

5. The method according to claim 4, wherein egress traffic frames are sent with a label leading to a port and Virtual Local Area Network (VLAN) said VPLS spoke is connected.

6. The method according to claim 1, wherein said egress traffic is rerouted via a Multi-protocol Label Switching (MPLS) tunnel leading to an MPLS spoke via the node of said second VSI and ending at a spoke node.

7. The method according to claim 6, further comprising using a transport entity label that identifies the transport entity between said second VSI and said MPLS spoke.

8. The method according to claim 6, further comprising said MPLS spoke forwarding egress traffic coming from the transport entity leading from said first VSI.

9. The method according to claim 1, wherein if only one of said first and second VSIs receive a frame, that VSI forwards said frame to the VPLS spoke regardless of its role as BMU-primary or BMU-secondary.

10. The method according to claim 1, wherein said first and second VSIs establish a BMU-primary VSI through Operations, Administration, and Maintenance (OAM) sessions maintained with the VPLS spoke.

11. The method according to claim 1, wherein BMU frames are identified in accordance with their destination Media Access Control (MAC) address.

12. The method according to claim 1, further comprising marking unicast frames at an ingress VSI with an indication of whether they are known or unknown, whereby unknown frames are forwarded to said VPLS spoke only by one of said first and second VSIs configured as a BMU-primary VSI.

13. The method according to claim 1, wherein said transport entity is selected from the group consisting of a pseudo-wire path, Multi-protocol Label Switching (MPLS)-PW path, and Virtual Local Area Network (VLAN) based point-to-point path.

14. A method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising:
upon occurrence of a switch-causing event, switching transmission of ingress traffic to said second VSI over said secondary transport entity in response to said switch-causing event;
rerouting egress traffic from said first VSI to said second VSI for forwarding to said VPLS spoke over said secondary transport entity in response to said switch-causing event;
electing the VSI the VPLS spoke sends ingress traffic to as the broadcast, multicast, unknown (BMU)-primary VSI and electing the other VSI as BMU-secondary; and
wherein if both said first and second VSIs receive a BMU frame, only said BMU-primary VSI forwards said BMU frame to the VPLS spoke thereby preventing duplicate broadcast, multicast, unknown (BMU) frames at the VPLS spoke.

15. The method according to claim 14, wherein said switch-causing event is selected from the group consisting of a link failure, network device failure, transport-entity failure, manual-switch command by an operator and expiration of a reversion-timeout when revertive operation is in use.

16. A method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising:
detecting a failure in said primary transport entity;
electing the VSI the VPLS spoke sends ingress traffic to as the broadcast, multicast, unknown (BMU)-primary VSI;
switching transmission of ingress traffic from first VSI to said second VSI over said secondary transport entity in response to said failure;
rerouting egress traffic from said first VSI to said second VSI for forwarding to said VPLS spoke over said secondary transport entity in response to said failure;
marking unicast frames with an indication of whether they are known or unknown; and
permitting only said BMU-primary VSI to forward BMU frames to the VPLS spoke thereby preventing duplication of BMU frames at the VPLS spoke.

17. The method according to claim 16, wherein said egress traffic is rerouted via a Multi-protocol Label Switching (MPLS) tunnel leading from said first VSI to said second VSI.

18. A method of fast protection in a network incorporating a dual homed Virtual Private Local Area Network (LAN) Service (VPLS) spoke connected to a first virtual switch instance (VSI) over a primary transport entity and to a second VSI over a secondary transport entity, the method comprising:
upon occurrence of a switch-causing event, electing the VSI the VPLS spoke sends ingress traffic to as the broadcast, multicast, unknown (BMU)-primary VSI in response to said switch-causing event;
switching transmission of ingress traffic from first VSI to said second VSI over said secondary transport-entity in response to said switch-causing event;
rerouting egress traffic from said first VSI to said second VSI for forwarding to said VPLS spoke over said secondary transport entity in response to said switch-causing event;
marking unicast frames with an indication of whether they are known or unknown; and
permitting only said BMU-primary VSI to forward BMU frames to the VPLS spoke thereby preventing duplication of BMU frames at the VPLS spoke.

19. The method according to claim 18, wherein said switch-causing event is selected from the group consisting of a link failure, network device failure, transport-entity failure, manual-switch command by an operator and expiration of a reversion-timeout when revertive operation is in use.

20. A switch for use in an Ethernet based network incorporating a Local Area Network (LAN) Service (VPLS) Virtual Switch Instance (VSI) to which a VPLS-spoke is connected through a primary transport entity, where said VPLS spoke device is also connected to a second VSI over a secondary transport entity, said switch comprising:
a plurality of network ports for interfacing said switch to one or more communication links;
a packet processor comprising an ingress packet processor and an egress packet processor;
a fast protection module operative to:
detect a failure in said primary transport entity;
receive unicast frames, marked at an ingress VSI in said network as to whether they are known at it or not;
reroute egress traffic and all unicast traffic that is marked as known and that needs to be sent to the VPLS-spoke to said second VSI for forwarding to said VPLS spoke over said secondary transport entity.

21. The method according to claim 20, wherein said egress traffic is rerouted via a Multi-protocol Label Switching (MPLS) tunnel leading from said first VSI to said second VSI.

22. The method according to claim 20, further comprising dropping broadcast, multicast, unknown (BMU) traffic destined to VPLS spokes for which said switch is BMU-secondary.
